(19) United States
(12) Patent Application Publication
(10) Pub. No.: US 2017/0328446 A1
(43) Pub. Date: Nov. 16, 2017

(54) GEAR REDUCTION ASSEMBLY

(71) Applicant: Jui-Lung TSAO, Nantou County (TW)

(72) Inventor: Jui-Lung TSAO, Nantou County (TW)

(21) Appl. No.: 15/592,811

(22) Filed: May 11, 2017

(30) Foreign Application Priority Data
May 12, 2016 (TW) 105114661

(51) Int. Cl. F16H 1/32

(52) U.S. Cl. CPC F16H 1/321

(57) ABSTRACT

A gear reduction assembly includes a gearbox, a stationary gear, an input shaft, a rotary gear, and an output shaft. Wherein the stationary gear having a first flange and anchoring in the gearbox. The input shaft passes through the stationary gear coaxially. One end of the input shaft is disposed a bearing sleeve, and the axis of the bearing sleeve is eccentrically deployed to the axis of the input shaft. The bearing sleeve is associated with the rotary gear by a bearing. The rotary gear having a drive pin and a second flange meshed to the first flange, and the teeth number of the first flange is unequal to the teeth number of the second flange. One end of the output shaft is a hub pivoted to the drive pin. By above-mentioned gear reduction assembly can make superior decelerating effect with compact components.

### BACKGROUND OF THE INVENTION

### 1. Field of the Invention

The invention relates to a speed reducing mechanism, and more particularly, is a gear reduction assembly with teeth number difference to generate superior decelerating effect.

### 2. Description of the Related Art

The traditional mechanism of the gear reduction was usually complicated and had components really redundant, it causing not only the difficulties for assembling and adjusting the gear compartments, but also turning out the production cost raise. Therefore, a gear reduction employs minimal components becomes a desirable invention.

### SUMMARY OF THE INVENTION

In view of this, one of the purposes of this invention is to provide a brand-new gear reduction assembly used less components.

To achieve above-mentioned purpose, this invention provide a gear reduction assembly including a stationary gear, an input shaft, a rotary gear, and an output shaft. Wherein the stationary gear anchoring in the gearbox and having a first clench surface, a first flange disposed on the first clench surface, and a through hole locating in the center of the stationary gear. By way of the through hole, the input shaft coaxially deployed with the stationary gear in the gearbox. One end of the input shaft connected to a bearing sleeve, and the axis of the bearing sleeve eccentrically positioned to the axis of the input shaft. The rotary gear is coaxially associated with the bearing sleeve by a bearing. The rotary gear comprises a drive pin near the center, a second clench surface, and a second flange disposed on the second clench surface. The second flange meshed to the first flange, and the teeth number of the first flange and the teeth number of the second flange are unequal. The output shaft has a hub rotationally pivoted to the drive pin in the gearbox.

Through the above-mentioned design of the gear reduction assembly, if the teeth number of the rotary gear is N and the teeth number of stationary gear is N−1, this invention can make N times decelerating effect by using minimal components, so that the speed reducing effect is superior and the cost is cheaper.

This invention provides another gear reduction assembly including a gearbox, a stationary gear, an input shaft, a rotary gear, and an output shaft. Wherein the stationary gear anchoring in the gearbox and having a first clench surface, a first flange disposed on the first clench surface. The stationary gear has a through hole. By way of the through hole, the input shaft and the stationary gear coaxially deployed in the gearbox. One end of the input shaft connected to a bearing sleeve, and the axis of the bearing sleeve eccentrically positioned to the axis of the input shaft.

The rotary gear is coaxially associated with the bearing sleeve by a bearing. Wherein the rotary gear comprises a second clench surface and a third clench surface in the opposite direction, a second flange disposed on the second clench surface, a third flange disposed on the third clench surface, and the second flange coupled to the first flange. The output gear rotationally installed in the gearbox and coaxially deployed with the stationary gear. Wherein the output gear has a fourth clench surface and a backside in the opposite direction, a fourth flange disposed on the fourth clench surface coupling to the third flange, and the output gear having an output shaft coaxially connected to the backside. Wherein the teeth number of the first flange and the second flange are unequal, and the teeth number of the third flange and the fourth flange are unequal. Besides, when the teeth number of the second flange and the teeth number of the third flange are equal, the teeth number of the first flange and the teeth number of the fourth flange are unequal.

Through the above embodiment of the gear reduction assembly, the invention can make N*(N+1) times decelerating effect by minimal components adoption if the teeth number of the first flange and teeth number of the third flange both are N, the teeth number of the second flange is N+1 and the teeth number of the fourth flange is N−1.

In one aspect, when the second flange has one more tooth than the first flange, and third flange may has more teeth than the fourth flange, the retard action of the first flange and the second flange may multiply the retard action of the third flange and the fourth flange turning out the strengthen decelerating effect. Similarly, the decelerating effect is increase when the teeth number of second flange is less than the teeth number of the first flange, and the teeth number of third flange may be less than the teeth number of the fourth flange.

### BRIEF DESCRIPTION OF THE DRAWINGS

FIG. 1 illustrates a perspective view of the first exemplary gear reduction of this invention;

FIG. 2 illustrates a sectional view of the first exemplary gear reduction of this invention;

FIG. 3 illustrates another sectional view of the first exemplary gear reduction of this invention;

FIG. 4 illustrates a perspective view of the second exemplary gear reduction of this invention; and

FIG. 5 illustrates a sectional view of the second exemplary gear reduction of this invention.

### DETAILED DESCRIPTION OF PREFERRED EMBODIMENTS

For better understanding the characteristics of this invention, this invention illustrates two embodiments as below. To make a brief description of the technical embodiments, hereinafter, the illustrations are projected from the right side of the output shaft 60 (or output gear 70) disposed on the left side of the gearbox 10, and the input shaft 32 located in the right side of the gearbox 10. However, this invention may be resorted to falling within the scope of the exemplary drawings but not included. Besides, all of the equivalents of the embodiments will continue the same use of serial number for easy recognition.

This invention of gear reduction assembly mainly comprises a gearbox 10, a stationary gear 20, an input shaft 32, a rotary gear 50, and an output shaft 60. The technical content, characteristics, and the function of this invention are specified as below:

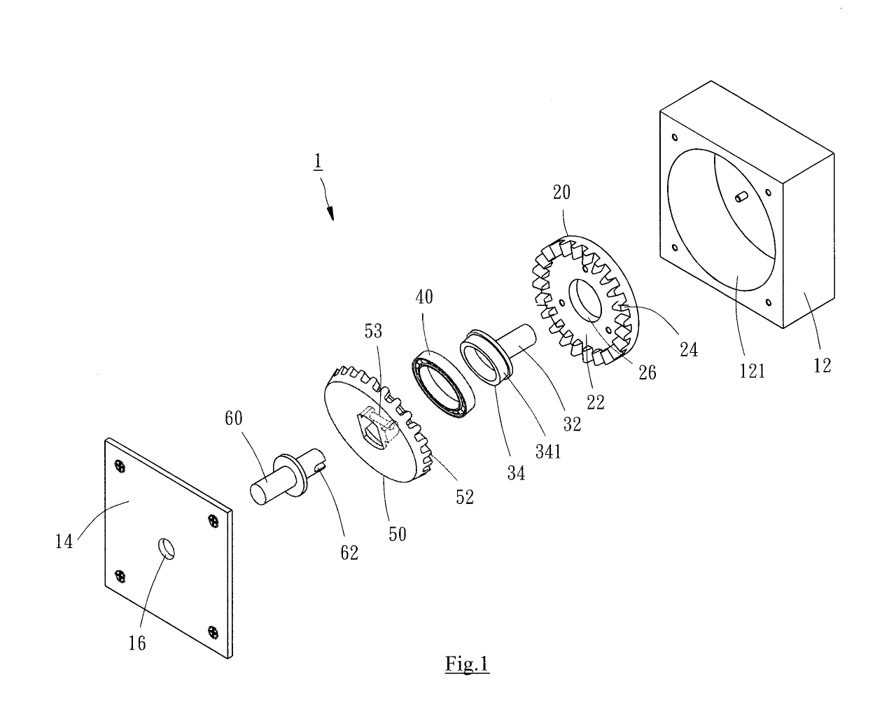

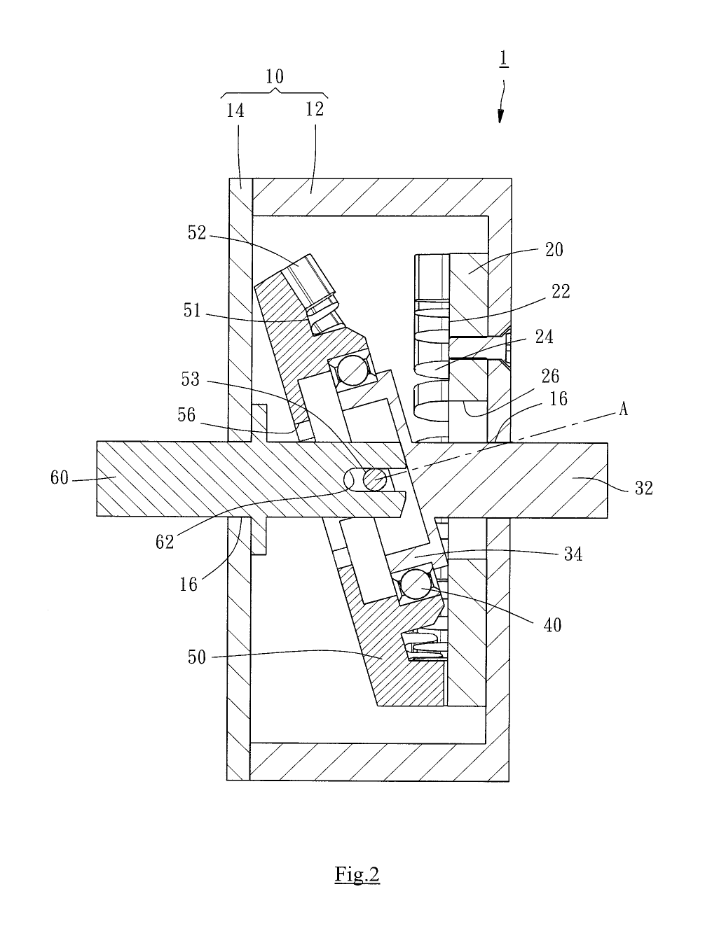

In FIG. 1 and FIG. 2, the gearbox 10 includes a case 12 and a cover 14 assembled by screws. Inside of the case 12 is an empty space 121 for installing the described-latter components: a stationary gear 20, an input shaft 32, a rotary gear 50, and an output shaft 60. The case 12 and the cover 14 have openings 16 for input shaft 32 and output gear 60 passing through.

The stationary gear 20 fixed on the inner wall of the gearbox 10. The stationary 20 has a first clench surface 22 facing opposite the inner wall and having a through hole 26 in its center. A first flange 24 disposed on the first clench surface 22, and the teeth number of the first flange 24 is N−1 (N is a positive integer greater than 1), and the stationary gear 20 is a one-side gear (or a zero-degree bevel gear) in this embodiment.

The input shaft 32 and the stationary gear 20 coaxially deployed in the gearbox 10; the right side of the input shaft 32 extrudes out of the gearbox 10 and the left side of the input shaft 32 passing through the through hole 26 protrudes out of the left side of the stationary gear 20. Besides, the bear sleeve 34 has a virtual axis A forming an angle with the input shaft 32 which means the bearing sleeve 34 and the input shaft 32 are eccentrically deployed. Besides, the bearing sleeve 34 has a cylindrical wall 341 coaxially jointed by a bearing 40 and eccentrically deployed with the input shaft 23. Herein to make a supplementary, the bearing 40 may integrated into the bearing sleeve 34 and the cylindrical wall 341 may become the inner ring of the bearing 40 to reduce components amount.

The rotary gear 50 penetrates through the bearing 40 and coaxially associated with the bearing sleeve 34 leading the eccentric arrangement to the rotary gear 50 and the input shaft 32. The rotary gear 50 has a second clench surface 51 facing to the first clench surface 22, and the second clench surface 51 has a second flange 52 with N teeth meshed to the first flange 24. The rotary gear 50 has a drive pin 53 and a hole 56 being equivalent to the axis of the rotary gear 50. The drive pin 53 is parallels to the second clench surface 51 and orthogonally intersects with the input shaft 60. In this embodiment, the rotary gear 50 is a bevel gear, and the drive pin 53 is disposed on the taper of the bevel gear.

The output shaft 60 rotationally pivoted to a cover 14 and coaxially deployed with the input shaft 32. The left side of the output shaft 60 extrudes out of the cover 14, and the right side of the output shaft 60 has a hub 62. The hub 62 forms a dent shape for the drive pin 53 shifting inside and keeps the output shaft 60 and the rotary gear 50 rotating synchronously and coaxially.

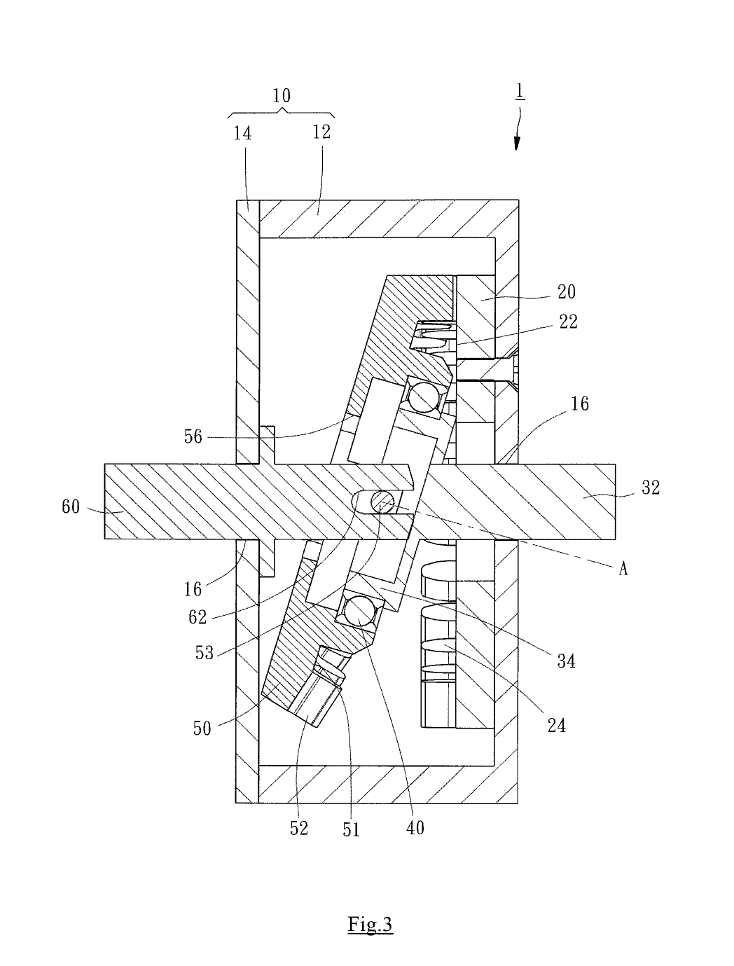

In FIGS. 2 and 3, when the input shaft 32 and the bearing sleeve 34 driven to rotate simultaneously, the bearing sleeve 34 idles as the connection to the bearing 40. The end of the bearing sleeve 34 pushes the rotary gear 50 to axially rotate about (procession) the input shaft 32, similar to the slow-down motion of Euler's Disk, and makes the rotary gear 50 rotationally mesh to the stationary gear 20. Since the rotary gear 50 has one more tooth than the stationary gear 20, when the input shaft 32 turns around the rotary gear 50 runs

$$\frac{360 °}{N} ,$$

and the output shaft 60 rotates

$$\frac{360 °}{N}$$

driven by the drive pin 53. In other words, it makes N times decelerating effect when the input shaft 32 rotates N loops, the output shaft 60 turns around only.

This embodiment of gear reduction assembly only employs a few components making superior decelerating effect and lowering down the producing cost entirely. It must be noted that the first embodiment may be altered the teeth number of the rotary gear 50 less by one than the teeth number of the stationary gear 20 to make similar decelerating effect. However, if the rotary gear 50 has more teeth than the stationary gear may help to deduce the eccentric situation of rotation. Besides, the teeth number of the rotary gear 50 may be altered more by two (or less by two . . . other teeth number can be deduced accordingly). When the teeth number of the rotary gear 50 differ by two with the teeth number of the stationary gear 20, the input shaft 32 goes N/2 round only, the output shaft 60 turns around, and the decelerating effect will be N/2 times.

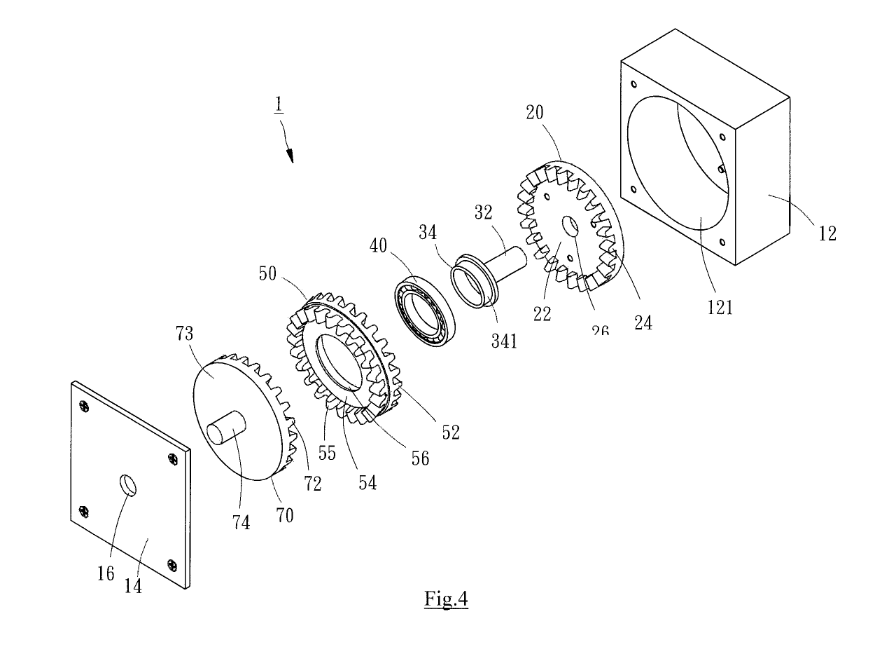

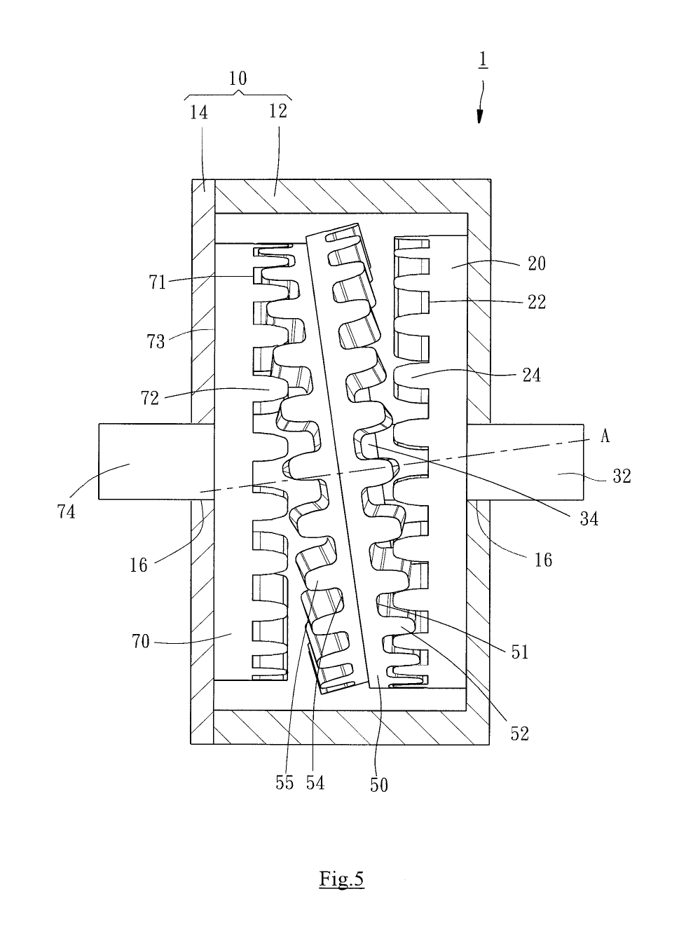

Base on single technique principle, this invention provides second embodiment as shown in FIGS. 4 and 5. Below will only mention the differences of the second embodiment but omit the similarities.

In the second embodiment, the stationary gear 20 screwed on the right side of the inner wall of the gearbox 10 and having a first clench surface 22 facing to the inner wall in the opposite direction. A first flange 24 disposed on the first clench surface 22 has teeth number N (N is positive integral), and the stationary gear 20 is a one-side gear in the second embodiment.

The rotary gear 50 connected to the outer edge of the bearing 40 and coaxially associated with a bearing sleeve 34 by the introduction of the bearing 40. The axis A of the rotary gear 50 eccentrically deployed with the axis of the input shaft 32. The rotary gear 50 has a second clench surface 51 and a third clench surface 54, both of them facing in opposite directions. The second flange 52 and the third flange 55 are sequentially disposed on the second clench surface 51 and on the third clench surface 54. Wherein the second clench surface 51 faces to the stationary gear 20 and the third clench surface 54 faces to the stationary gear 20 in opposite directions, and the second clench surface 52 coupled to the first clench surface 24. Besides, in the second embodiment, the teeth number of the second flange 52 is N+1, and the teeth number of the third flange 55 is N.

The output gear 70 rotationally pivoted to the cover 14 and coaxially deployed with the stationary gear 20. The output gear 70 has a fourth clench surface 71, a backside 73, and a fourth flange 72. The fourth flange 72 is disposed on the fourth clench surface 71 coupled to the third flange 55. The teeth number of the fourth flange 72 is N−1, and the output gear 70 has an output gear 74 coaxially disposed on the backside and extruded out of the cover 14.

When used with, the input shaft 32 driven to rotate with the bearing sleeve 34, and the bearing sleeve 34 idles accordingly because of the transmission of the bearing 40. Simultaneously the bearing sleeve 34 pushes the rotary gear 50 to rotate about the input shaft 32, and at the same time, the second flange 52 rotationally couple to the stationary gear 20, and the third flange 55 mesh to the output gear 70. Because the second flange 52 has teeth number (N+1) by one more than the first gear 24 has teeth number (N), when the input shaft 32 turns around, the rotary gear 50 rotates

$$\frac{360 °}{N + 1}$$

in a clockwise direction looking from the right side to left side. On the other side, because the third flange 55 has teeth number (N) by one more than the forth gear 72 has teeth number (N−1), when the input shaft 32 turns around the second flange 52 couples to the first flange 24 which leads the output gear 79 to turn

$$\frac{360 °}{N}$$

in an anti-clockwise direction and results in the output shaft 70 rotates only

$$\frac{360 °}{N} - \frac{360 °}{N + 1}$$

equal to

$$\frac{360 °}{( N + 1 ) N}$$

accomplishing (N=1)N times decelerating effect.

In the second embodiment, the first clench surface 22 are coaxially deployed with the forth clench surface 71 keeping the input shaft 32 and the output shaft 74 in coaxial position. Since the second clench surface 52 and the third clench surface 54 are deployed on the opposite side of the rotary gear 50 where is an eccentric position to the aforesaid first clench surface 22 and the forth clench surface 71. Therefore, movement creations of the first clench surface 22 and the second clench surface 52, and of the third clench surface 54 and the forth clench surface 71 contribute two times decelerating effect.

It noted that the teeth number of the first flange 25 and the teeth number of the second flange 52 are unequal, and the teeth number of the third flange 55 and the teeth number of the fourth flange 72 may be unequal too. Which means by way of moving the rotary gear 50 to realize the decelerating effect. However, when the teeth number of the second flange 52 (e.g. N) and the teeth number of the third flange 55 (e.g. N) are equal, the teeth number of the first flange 24 (e.g. N−1) may not be equal to the teeth number of the second flange 52 (e.g. N−1) in case of the output shaft 74 going on strike (which means the decelerating rate is infinite).

Besides, the deceleration output is strengthened when the teeth number of the second flange 52 is more than the teeth number of the first flange 24. The teeth number of the third flange 55 may be more than the teeth number of the fourth flange 72, and the decelerating effect of the first flange 24 and the second flange 52 multiplies the decelerating effect of the third flange 55 and the fourth flange 72. Furthermore, it makes the excellent decelerating effect when the decelerating ratio of the first flange 24 and second flange 52 comes near to the decelerating ratio of the third flange 55 and the fourth flange 72, and both of them rotate contrarily. Similarly, it may as well strengthen the decelerating outcome when the teeth number of the second flange 52 is less than the teeth number of the first flange 24, the teeth number of the third flange 55 is less than the teeth number of the fourth flange 72.

Last but not the least, the design of the clench surface is not limited to the flange shape; any equivalent can do the tricks is acceptable.

What is claimed is:

1. A gear reduction assembly comprising:
a gearbox;
a stationary gear, installed in the gearbox and having a first clench surface, and a first flange disposed on the first clench surface; the stationary gear has a through hole;
an input shaft, passing through the through hole and coaxially deployed with the stationary gear in the gearbox; one side of the input shaft connected to a bearing sleeve, and the axis of the bearing sleeve eccentrically deployed to the input shaft;
a rotary gear, rotationally and coaxially connected to the bearing sleeve, the rotary gear having a drive pin, a second clench surface, and a second flange disposed on the second clench surface meshed to the first flange; the teeth number of the first flange and the teeth number of the second flange are unequal; and
an output shaft, rotationally disposed in the gearbox and having a hub pivoted to the drive pin.

2. The gear reduction assembly of claim 1, wherein the discrepancy of the teeth number between the first flange and the second flange is one.

3. The gear reduction assembly of claim 2, wherein the second flange has one more teeth than the second flange.

4. The gear reduction assembly of claim 1, wherein the rotary gear is a bevel gear; the drive pin is on the taper of the bevel gear.

5. The gear reduction assembly of claim 4, wherein the rotary gear is associated with the bearing sleeve by a bearing, and the bearing integrates into the bearing sleeve.

6. A gear reduction assembly comprising:
a gearbox;
a stationary gear, installed in the gearbox and having a first clench surface, and a first flange disposed on the first clench surface; the stationary gear has a through hole;
an input shaft, passing through the through hole and coaxially deployed with the stationary gear in the gearbox; one side of the input shaft connected to a bearing sleeve, and the axis of the bearing sleeve eccentrically deployed to the input shaft;
a rotary gear, rotationally and coaxially connected to the bearing sleeve, the rotary gear has a second clench surface and a third clench surface in the opposite directions, a second flange disposed on the second clench surface and a third flange disposed on the third clench surface, the second flange is meshed to the third flange; and
an output gear, rotationally installed in the gearbox and coaxially deployed with the stationary gear, the output gear having a fourth clench surface and a backside in the opposite direction, and a fourth flange coupled to the third flange, the output gear having an output shaft coaxially deployed on the backside;
wherein the teeth number of said first flange and the teeth number of the second flange are unequal, and the teeth number of the third flange and the teeth number of the fourth flange are unequal.

7. The gear reduction assembly of claim 6, wherein the teeth number of the second flange and the teeth number of the third flange are equal, and the teeth number of the first flange and the teeth number of the fourth flange are unequal.

8. The gear reduction assembly of claim 6, wherein the teeth number of the first flange and the teeth number of the third flange are equal, the second flange has one more tooth than the first flange, and the fourth flange has one less tooth than the third flange.

9. The gear reduction assembly of claim 6, when the teeth number of the second flange is more than the teeth number of the first flange, the teeth number of the third flange is more than the teeth number of the fourth flange; when the teeth number of the second flange is less than the teeth number of the first flange, the teeth number of the third flange is less than the teeth number of the fourth flange.

10. The gear reduction assembly of claim 7, wherein the rotary gear is associated with the bearing sleeve by a bearing, and the bearing integrated into the bearing sleeve.
